(19) United States
(12) Patent Application Publication
(10) Pub. No.: US 2014/0283433 A1
(43) Pub. Date: Sep. 25, 2014

(54) Spring-Loaded Fish Hook

(71) Applicant: Robert Gafford, Cortez, CO (US)

(72) Inventor: Robert Gafford, Cortez, CO (US)

(21) Appl. No.: 14/220,347

(22) Filed: Mar. 20, 2014

Related U.S. Application Data
(60) Provisional application No. 61/804,949, filed on Mar. 25, 2013.

(51) Int. Cl. A01K 83/02

(52) U.S. Cl. CPC A01K 83/02
USPC 43/36; 43/35

(57) ABSTRACT

Disclosed is a spring-loaded fish hook comprising a first hook connected to a first shaft and a second hook connected to a second shaft. The shafts are connected to a resistance element that biases the shafts apart from one another. A first shaft has a catch element, and a second shaft has a slide element that is adapted to slide along said second shaft. The spring-loaded fish hook device can be arranged in a closed configuration in which the shafts are urged towards one another and are held in position by means of the slide element engaging with the catch element. A releasing line is connected to the slide element, and by pulling on the releasing line, the slide element can be disengaged from the catch element, allowing the resistance element to forcibly separate the shafts, and thus the hooks, from one another resulting in an open configuration.

### CROSS REFERENCE TO RELATED APPLICATION

This application claims the benefit of U.S. Provisional Application No. 61/804,949 filed on Mar. 25, 2013, entitled “Spring-Loaded Fish Hook Device.” The above identified patent application is herein incorporated by reference in its entirety to provide continuity of disclosure.

### BACKGROUND OF THE INVENTION

1. Field of the Invention

The present invention relates to a fish hook device. More specifically, the present invention relates to a spring-loaded fish hook device comprising a first hook attached to a first shaft and a second hook attached to a second shaft, wherein said first and second shafts are connected to a resistance element. The resistance element biases the shafts apart from one another, but the shafts can be held together in a closed configuration by engaging a catch element positioned on the first shaft with a slide element movably secured to the second shaft. A releasing line is provided that engages with the slide element and allows a user to disengage said slide element from said catch element such that the shafts of the fish hook will expand apart into an open configuration.

Fish hooks are commonly used to catch fish and operate by snagging the interior of a fish's mouth. Fish hooks are generally attached to a fishing line on a fishing rod and may further include bait or lure to attract fish towards the hook. Traditional hooks include a solid piece of curved metal having a shank, a bend, and a point. The point may further include a barb such that when a fish is caught on the point, the barb prevents the fish from breaking free. However, since traditional hooks are solid pieces of material that remain static in the water, a fish may be able to bite the bait or lure without becoming caught on the hook. Even when a fish is caught on the barbed point of the hook the fish may thrash and struggle, enabling the fish to break free from the hook.

Spring-loaded hooks are known in the art and are better able to ensnare a fish that is attracted to the lure or bait on the hook. Such devices comprise one or more hooks held under tension and that can be released from tension such that a spring forces a hook into a fish's mouth. In this way, spring-loaded fish hooks are more active in attempting to snag a fish, and the force of the spring makes it difficult for a fish to free itself from the fish hook. However, many of these devices can be difficult to operate and may not function as intended. When using a spring-loaded fish hook known in the art, it may be difficult for the user to release the hook from a closed configuration once a fish bites the hook. Alternatively, spring-loaded devices known in the art may be difficult to maintain in a closed configuration, and may unexpectedly release from the closed configuration. If the fish hook fails to release from the closed configuration, or if the fish hook releases from the closed configuration prematurely, the user's ability to catch a fish using the spring-loaded fish hook will be diminished. In this regard, an improved spring-loaded fish hook that is easily to operate and that has a more reliable release mechanism is desired.

Disclosed is a spring-loaded fish hook device comprising one or more hooks each connected to a shaft. The shafts are connected to a resistance element, such as a spring, that urges the shafts apart from one another. A first shaft comprises a catch element, while a second shaft comprises a slide element. The fish hook can be held in a closed configuration by urging the shafts towards one another, and engaging the slide element with the catch element. A releasing line is connected to the slide element, and when the releasing line is pulled, the slide element disengages from the catch, allowing the resistance element to forcefully separate the hooks from one another, in an attempt to ensnare a fish.

2. Description of the Prior Art

Devices have been disclosed in the prior art that relate to fish hooks. These include devices that have been patented and published in patent application publications. These devices generally relate to spring-loaded fish hooks. The following is a list of devices deemed most relevant to the present disclosure, which are herein described for the purposes of highlighting and differentiating the unique aspects of the present invention, and further highlighting the drawbacks existing in the prior art.

Traditional fish hooks have several known drawbacks that prevent the fish hooks from effectively ensnaring a fish. Once a traditional fish hook is attached to a line and placed in the water, the fish hook is static and cannot change configuration. Thus, a fish can only be caught if the fish ensnares itself on the point of the hook or a barb on the hook. Despite being impaled by the point of the fish hook, the writhing of the fish may allow the fish to free itself from the fish hook.

Spring-loaded fish hooks are known in the art but are difficult to operate and operate inconsistently. If the user is unable to disengage the slide element from the catch element of the fish hook, the fish will likely not be caught, even if the fish places the fish hook in its mouth. Alternatively, if the slide disengages from the catch unexpectedly, the advantage provided by the spring-loaded fish hook cannot be realized. Thus, a spring-loaded fish hook that is easy to operate and that can reliably release from a closed configuration is desired.

In light of the devices known in the prior art, it is submitted that the present invention substantially diverges in design elements from the prior art and consequently it is clear that there is a need in the art for an improvement to existing spring-loaded fish hook devices. In this regard the instant invention substantially fulfills these needs.

### SUMMARY OF THE INVENTION

In view of the foregoing disadvantages inherent in the known types of fish hook devices now present in the prior art, the present invention provides a new spring-loaded fish hook wherein the same can be utilized for providing convenience for the user when catching fish using a fish hook.

It is therefore an object of the present invention to provide a new and improved fish hook device that has all of the advantages of the prior art and none of the disadvantages.

It is another object of the present invention to provide a fish hook that is spring-loaded and helps a user to catch fish.

Another object of the present invention is to provide a spring-loaded fish hook that is easily maintained in a closed configuration and that can be easily released from the closed configuration.

Yet another object of the present invention is to provide a spring-loaded fish hook that shields its barbs when in a closed position so as to prevent the barbs from catching on underwater vegetation or debris.

Another object of the present invention is to provide a spring-loaded fish hook that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a view of a first embodiment of the present invention in a closed configuration.

FIG. 1B shows a view of a first embodiment of the present invention in an open configuration.

FIG. 2 shows a second embodiment of the fish hook of the present invention having lures attached thereto.

FIG. 3 shows a third embodiment of the fish hook of the present invention having bait attached thereto.

FIG. 4 shows a fourth embodiment of the fish hook of the present invention having a different arrangement of lures attached thereto.

### DETAILED DESCRIPTION OF THE INVENTION

Reference is made herein to the attached drawings. Like reference numerals are used throughout the drawings to depict like or similar elements of the spring-loaded fish hook device. For the purposes of presenting a brief and clear description of the present invention, the preferred embodiment will be discussed as used for catching fish using a fish hook disposed on a fishing line. The figures are intended for representative purposes only and should not be considered to be limiting in any respect.

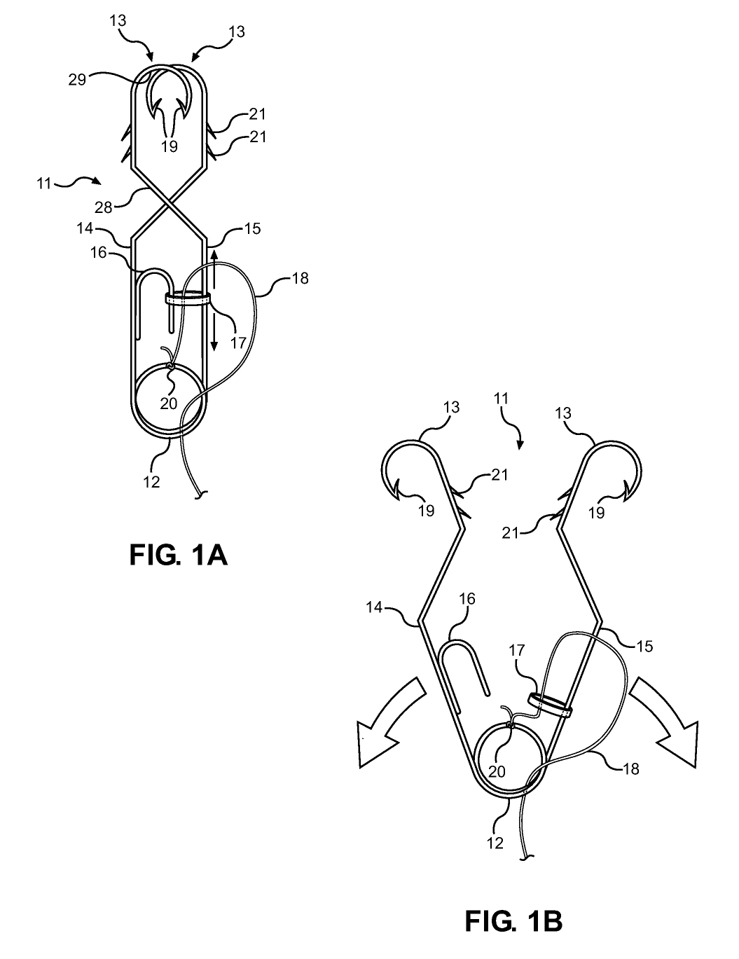

Referring now to FIGS. 1A and 1B, there are shown views of a first embodiment of the present invention in a closed and an open configuration, respectively. The fish hook 11 comprises a first hook 13 disposed on a first shaft 14 and a second hook 13 disposed on a second shaft 15. The first and second shafts 14,15 are connected to a resistance element 12 that biases the shafts apart from one another such that the device prefers to be in the open configuration of FIG. 1B. The resistance element 12 exerts forces on the shafts 14,15 in opposing directions.

The first shaft 14 comprises a catch element 16 adapted to engage with a slide element. In the embodiment shown, the catch element 16 is U-shaped and has a first end connected to the first shaft 14 and a second end that is substantially parallel to the first shaft 14. The second shaft 15 comprises a slide element 17 that is adapted to slide up and down the second shaft 15. In the embodiment shown, the slide element comprises a ring member, commonly referred to as a bead, slidably connected to the second shaft 15. The slide element 17 has an open interior area and the slide element is adapted to engage with the catch element 16 so as to hold the first and second shafts 14,15 together under tension in a closed configuration as shown in FIG. 1A.

The slide element 17 can be disengaged from the catch element 16 by means of a releasing line 18 that is free at one end and that is tied to the fish hook 11 at the other end 20. The releasing line 18 may be secured to the fish hook 11 at various locations, and in the embodiment shown, the releasing line 18 is secured to the resistance element 12. The releasing line 18 is adapted to engage the slide element 17 such that the slide element can be disengaged from the catch element. Further, the releasing line 18 extends through a loop formed by the resistance element 12 which helps to direct the releasing line 18 and constrain the movement thereof. For example, where the slide element is a ring member, the releasing line is secured at one end to the resistance element 12, is passed through the open interior area of the slide element, and passes through a loop formed by the resistance element. Thus, the releasing line 18 wraps partially around a portion of the slide element 17, such that when the releasing line is pulled by a user, the releasing line catches on the slide element and pulls the slide element off of the catch element.

In operation, the fish hook 11 is secured in the closed configuration of FIG. 1A and is attached to a fishing line. The closed configuration has a relatively small profile such that a fish can easily insert the fish hook into the fish's mouth. Once the fish hook enters the fish's mouth, the fisherman may pull the releasing line 18 which causes the slide element 17 to disengage with the catch element 16 causing the fish hook 11 to forcefully expand into the open configuration of FIG. 1B. The points 19 of the hooks 13 will snag the interior of the fish's mouth, and the barbs will prevent the fish from freeing itself from the fish hook 11. Further, the expanded shape of the open configuration makes it particularly difficult for the fish to free itself from the fish hook, and the open configuration may serve to lodge the fish hook 11 into the fish's mouth.

Each hook 13 of the present invention comprises a shank 28, a bend 29, and a point 19. In the embodiment shown in FIG. 1A, the shank 28 includes a first section and a second section, wherein said first section connects to a shaft 14,15 and extends at an angle therefrom, and wherein said second section is substantially parallel to a shaft 14,15. In the embodiment shown in FIGS. 1A and 1B, the shank 28 further includes one or more barbs 21 that may snag the mouth of a fish. The bend 29 of the hook 13 curves from the shank towards a point 19 that includes a barb. The barb prevents a fish from escaping the hook once the hook impales the fish's mouth. In the embodiment shown in FIG. 1A, the hooks are arranged such that the points 19 of the hooks 13 are enclosed by the shank of the opposite hook. In this way, the points of the hook are shielded by the shanks, which prevents the points or barbs from snagging on any vegetation or debris underwater. This is particularly important when fishing for bass, wherein it is desirable to drag a hook or lure through underwater weeds where bass prefer to feed.

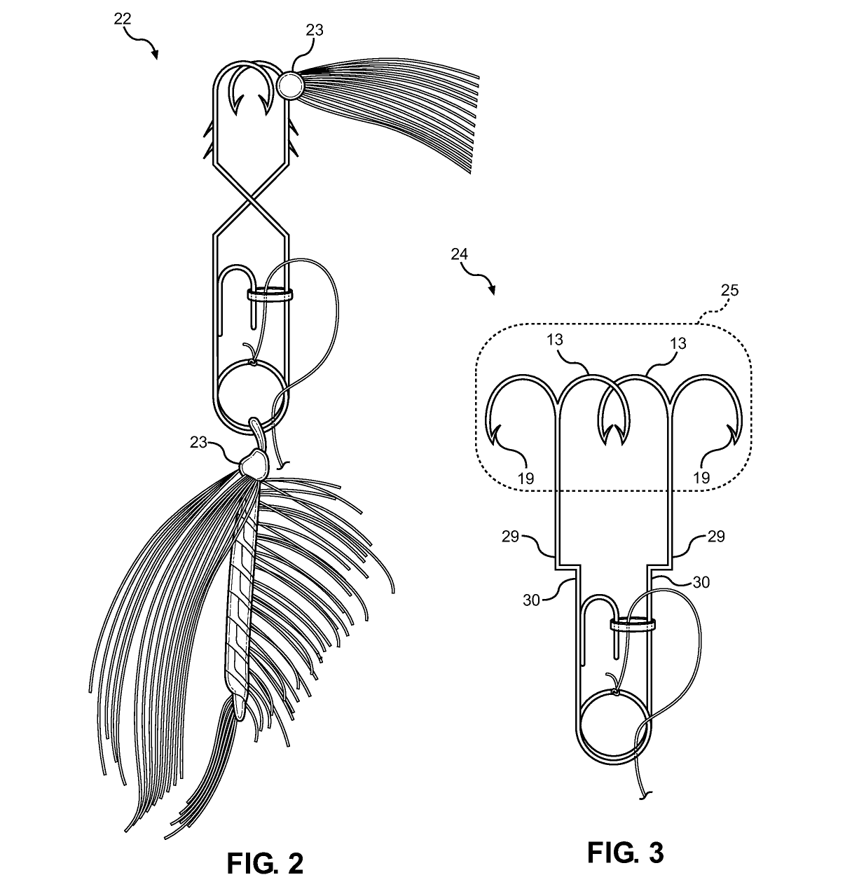

Referring now to FIG. 2, there is shown a second embodiment of the fish hook of the present invention having lures attached thereto. The fish hook 22 shown includes fishing lures 23 attached to various portions of the fish hook. Lures help to attract fish towards the hook, and the lures may come in a variety of shapes, sizes, patterns, and designs. For example, the lures may have bright coloring to attract fish and may include a plurality of thin strands that wave in the water. Further, the lure may be styled so as to resemble a small fish. The lures do not affect the operation of the spring-loaded fish hook of the present invention and allow the fish hook to function in the intended manner.

Referring now to FIG. 3, there is shown a third embodiment of the fish hook of the present invention having bait attached thereto. In the embodiment shown, the fish hook 24 includes multiple hooks 13 disposed on each shaft 30. Additional hooks may help to increase the likelihood that one of the hooks will catch on the interior of a fish's mouth. The hooks are shown as arranged in the same plane, but some embodiments of the fish hook may have hooks arranged in different planes. The hooks as shown comprise barbs on the points of the hooks. Additionally, the shank 29 of each hook has a first section perpendicular to the shaft 30 and a second section parallel to the shaft 30. Further, the fish hook 24 is fitted with bait 25 that is positioned on the hooks 13 and that substantially or partially covers the hooks. The bait 25 is positioned such that the bait does not interfere with the operation of the fish hook, and the shafts are able to expand apart from one another when the slide element is disengaged with the catch element.

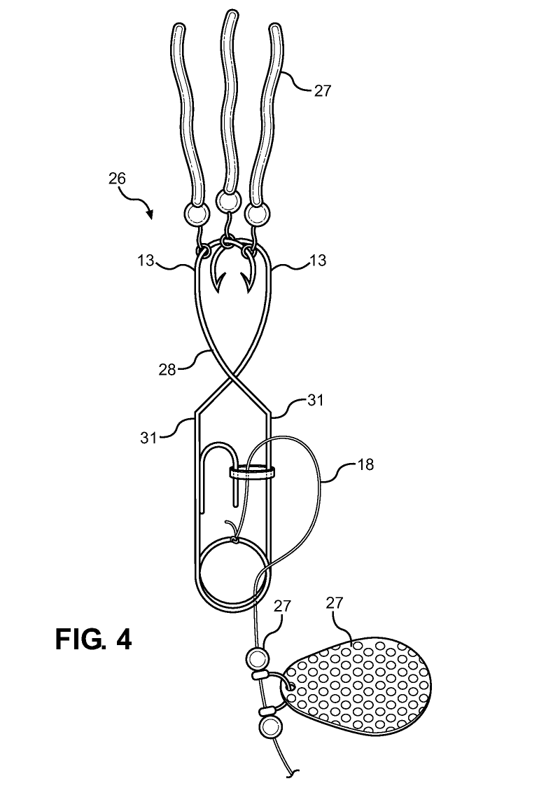

Referring now to FIG. 4, there is shown a fourth embodiment of the fish hook of the present invention having a different arrangement of lures attached thereto. The fish hook 26 has pieces of lure 27 attached to the hooks 13 and also to the releasing line 18. The hooks 13 of the fish hook 26 comprise lures 27 that wave in the water. The releasing line 18 comprises a piece of lure 27 that may resemble a small fish. Lure can be attached to various portions of the fish hook as desired by the user. In the embodiment shown, the shank 28 of the hook 13 is a single curved segment that extends outward from the shaft 31 at an angle. The points of the hooks 13 are positioned so as to be enclosed by the shank of the opposing hook.

The present invention provides a spring-loaded fish hook comprising a first hook connected to a first shaft and a second hook connected to a second shaft. The first and second shaft are connected to a resistance element that biases the shafts apart from one another. The first shaft further comprises a catch element, and the second shaft further comprises a slide element adapted to move up and down the second shaft. The fish hook can be held in a closed configuration under tension by engaging the slide element with the catch element. A releasing line is adapted to engage with the slide element such that a user can disengage the slide element from the catch element by pulling the releasing line. Once the slide element disengages with the catch element, the fish hook expands forcefully into an open configuration.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A fish hook comprising:
a first hook connected to a first shaft and a second hook connected to a second shaft;
wherein said first shaft and said second shaft are connected to a resistance element;
wherein said resistance element biases said first and second shaft apart from one another;
a catch element disposed on said first shaft;
a slide element disposed on said second shaft and adapted to slide thereon;
wherein engagement of said slide element with said catch element functions to hold said first and second shafts under tension in a closed configuration;
a releasing line adapted to engage with said slide element;
wherein said releasing line is adapted to disengage said slide element from said catch element when said releasing line is pulled, allowing said first and second shafts to move apart from one another so as to result in an open configuration.

2. The fish hook of claim 1, wherein said first and second hooks comprise one or more barbs.

3. The fish hook of claim 1, wherein said resistance element is a spring.

4. The fish hook of claim 1, wherein a first end of said releasing line is attached to said resistance element, and wherein said releasing line passes through said slide element.

5. The fish hook of claim 1, wherein said first and second hooks each comprise a shank, wherein said shanks comprise a first section and a second section, wherein said first section extends from said first or second shaft at an angle, and wherein said second section is substantially parallel to said first or second shaft, respectively.

6. The fish hook of claim 1, further comprising one or more fishing lures attached to said fish hook.

7. The fish hook of claim 1, wherein said slide element is a ring member adapted to engage with said catch element.

8. The fish hook of claim 1, wherein said catch element is U-shaped and comprises a first portion and second portion, wherein said first portion is connected to said first shaft, and wherein said second portion is substantially parallel to said first shaft.

9. The fish hook of claim 1, wherein said first and second hook each comprises a shank, said shanks having one or more barbs.

10. The fish hook of claim 1, wherein said first and second hook each comprises a shank, and wherein said shanks are curved.
